(19) United States
(12) Patent Application Publication
(10) Pub. No.: US 2016/0181032 A1
(43) Pub. Date: Jun. 23, 2016

(54) SEALABLE SETTINGS DIAL

(71) Applicant: SCHNEIDER ELECTRIC USA, INC., PALATINE, IL (US)

(72) Inventors: Conrad S. WEIDEN, Chapel Hill, NC (US); Hien NGUYEN, Chapel Hill, NC (US); Kevin M. JEFFERIES, Raleigh, NC (US)

(21) Appl. No.: 14/573,039

(22) Filed: Dec. 17, 2014

(51) Int. Cl. H01H 19/54

(52) U.S. Cl. CPC H01H 19/54

(57) ABSTRACT

A sealable settings dial assembly includes a casing for electrical equipment, such as an overload relay, and a rotatable dial. The casing includes a wire slot through which to extend a wire of a wire lock mechanism. The rotatable dial is movable relative to the casing, and is used to select a setting from a plurality of different settings for the electrical equipment. The dial includes spaced apart setting channels, such as setting holes or grooves, associated with the different settings to be selected. On the dial, each setting has an associated setting channel which aligns with the wire slot of the casing when the particular setting is selected on the dial. In that way, the wire can be extended through the wire slot and the setting channel for the selected setting to lock the dial at the selected setting.

### FIELD

The present disclosure is related to a system and method of locking a setting for electrical equipment, and more particularly, a sealable settings dial assembly.

### BACKGROUND

Overload relays or other electrical equipment can employ a setting mechanism, such as a dial, to enable a user to select operational parameters. For example, in overload relays, the operational parameters can include a full or maximum current. Once selected, the setting mechanism for the overload relay is typically locked to prevent inadvertent or unwanted change of the setting for the electrical equipment. For example, a separate plastic cover can be incorporated onto a casing of the electrical equipment, such as over the setting mechanism, and “locked” with a wire seal to prevent the selected setting from being changed. However, the use of such a lock assembly requires additional components to indirectly lock the setting mechanism, which increases the overall cost and complexity of the electrical equipment.

### SUMMARY

To address these and other shortcomings, there is provided a sealable settings dial assembly for electrical equipment, which allows the dial to be directly locked at a selected setting. For example, the sealable settings dial assembly can include a casing for the electrical equipment, such as for example an overload relay, and a rotatable dial operatively connected to a switch (e.g., a rotary switch). The casing includes a wire slot through which to extend a wire of a wire lock mechanism. The rotatable dial is movable relative to the casing, and is used to select a setting from a plurality of different settings for the electrical equipment. The dial can include setting indicators, e.g., visual markers, identifying each available setting. The dial also includes spaced-apart setting channels, e.g., setting holes or grooves, associated with the different settings. Each setting on the dial has an associated setting channel which aligns with the wire slot of the casing when the particular setting is selected on the dial. In that way, the wire of the wire lock mechanism can be extended through the wire slot and the setting hole or groove for the selected setting to lock the dial at the selected setting. The sealable settings dial assembly eliminates the need for additional components, such as a plastic cover. The dial can be a vertically or flat mounted in the casing, and includes a shaft which engages the rotary switch to control a setting for the electrical equipment.

### BRIEF DESCRIPTION OF THE DRAWINGS

FIG. 1 illustrates a perspective view of electrical equipment, which incorporates a sealable settings dial assembly in accordance with a first embodiment of the present disclosure.

FIG. 2 illustrates a view of the components of the sealable settings dial assembly of FIG. 1 in accordance with the first embodiment of the present disclosure.

FIG. 3 illustrates a cross-sectional view of the sealable settings dial assembly of FIG. 2 in accordance with the first embodiment of the present disclosure.

FIG. 4 illustrates a side view of the components of the sealable settings dial assembly of FIG. 1 in accordance with the first embodiment of the present disclosure.

FIG. 5 illustrates a perspective view of electrical equipment, which incorporates a sealable settings dial assembly in accordance with a second embodiment of the present disclosure.

FIG. 6 illustrates a cross-sectional view of the sealable settings dial assembly of FIG. 5 in accordance with the second embodiment of the present disclosure.

FIG. 7 illustrates a top view of the components of the sealable settings dial assembly of FIG. 5 in accordance with the second embodiment of the present disclosure.

FIG. 8 illustrates another top view of the components of the sealable settings dial assembly of FIG. 5 with a wire lock mechanism engaged thereto in accordance with the second embodiment of the present disclosure.

### DETAILED DESCRIPTION OF THE EXAMPLE EMBODIMENTS

The present disclosure describes various exemplary embodiments of a sealable settings dial assembly for electrical equipment. The settings dial assembly includes a rotatable settings dial movably mounted relative to a casing and operable to select a setting from a plurality of different settings for the electrical equipment. The settings dial includes a plurality of spaced-apart setting channels, such as setting holes (e.g., through holes) or grooves, associated with the selectable settings. When a setting is selected, the channel on the settings dial, which is associated with the selected setting, aligns with one or more wire slots on the casing. As a result, the wire from the wire lock mechanism can then be inserted through the wire slot and the channel to lock the settings dial at the selected setting. Accordingly, the settings dial assembly allows the dial to be directly locked at a selected setting from a plurality of selectable different settings using a wire lock mechanism. The term “wire” can include any elongated piece or component which is configured to fit and extend through the wire slot(s) and a setting channel to limit movement of the settings dial at a selected setting. The wire can be formed of metal or non-metal (e.g., plastic). Examples of a sealable settings dial assembly are described in further detail below with reference to the Figures.

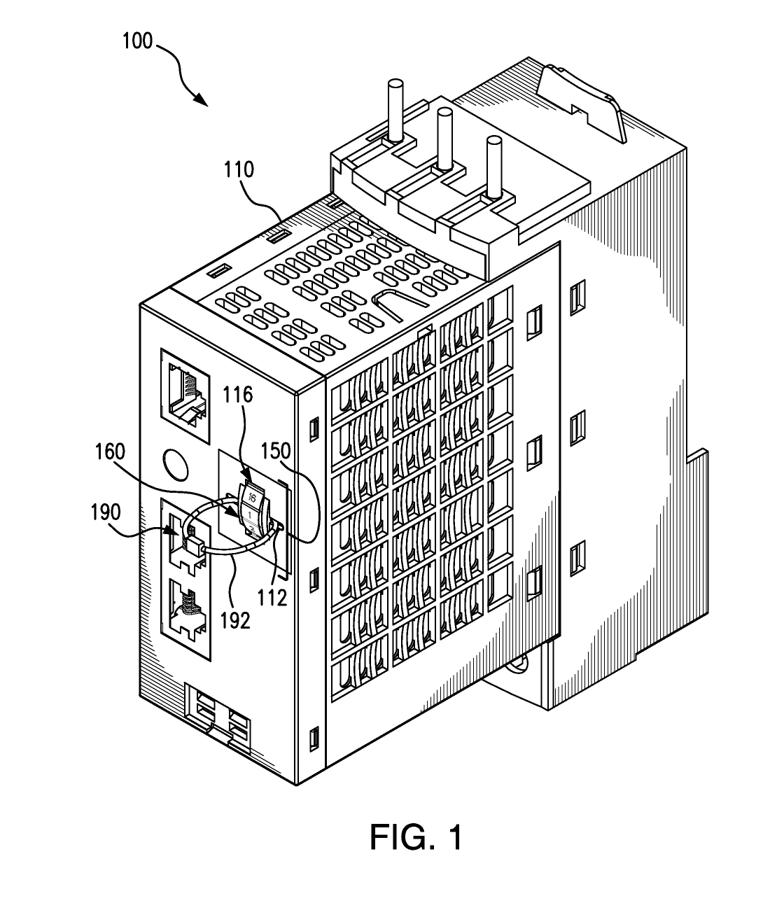

FIG. 1 illustrates a sealable settings dial assembly 150 for electrical equipment 100 in accordance with a first embodiment of the present disclosure. The dial assembly 150 includes a rotary settings dial 160 and a wire lock mechanism 190 with a wire 192. The settings dial 160 is vertically mounted in a casing 110 and rotates relative to the casing 110. The settings dial 160 is operable to enable selection of a setting from a plurality of different settings for the electrical equipment 100. As shown, the wire 192 is directly engaged with the settings dial 160 through a wire slot(s) 112 adjacent to the settings dial 160 to lock the settings dial 160 at a selected setting. In this example, the casing 110 includes two wire slots 112A and 112B, which are arranged on opposing sides of a portion of the dial 160, which is visible through an indicator window 116 of the casing 110.

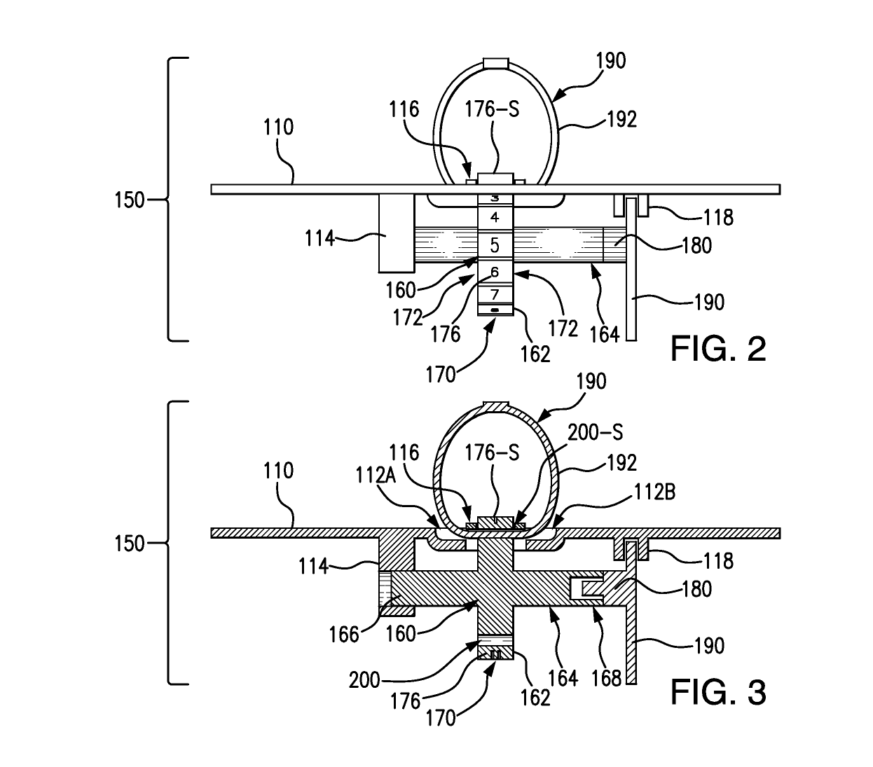

As shown in FIGS. 2 and 3, the settings dial 160 includes a wheel 162 and a shaft 164 fixed thereto. The shaft 164 extends through or from a center of the wheel 162, and includes a first end 166 and an opposing second end 168. The first end 166 of the shaft 164 is mounted to rotate on a dial support 114, which can be connected to or formed as part of the casing 110. The second end 168 of the shaft 164 is connected to a rotary switch 180 on a printed circuit board (PCB) 190. The rotary switch 180 can be a digital switch. The PCB 190 is mounted to the casing 110 via a switch support 118. The wheel 162 is substantially cylindrical and includes an outer face 170 on an outer diameter of the wheel 162 between opposing circular ends 172. The outer face 170 includes spaced apart setting indicators 176 associated with the different settings. In this example, the setting indicators 176 are visible markers, e.g., 1, 2, 3 . . . N, where N can be a number of available settings. Other types of visible markers (e.g., colors, numbers, symbols or a combination thereof) can be used depending on the operational parameter to be set for the electrical equipment. The setting indicator 176-S associated with a selected setting is visible through the indicator window 116. The wheel 162 also includes a plurality of setting channels in the form of setting holes 200, which are associated with the selectable settings and their respective setting indicators 176 on the settings dial 160.

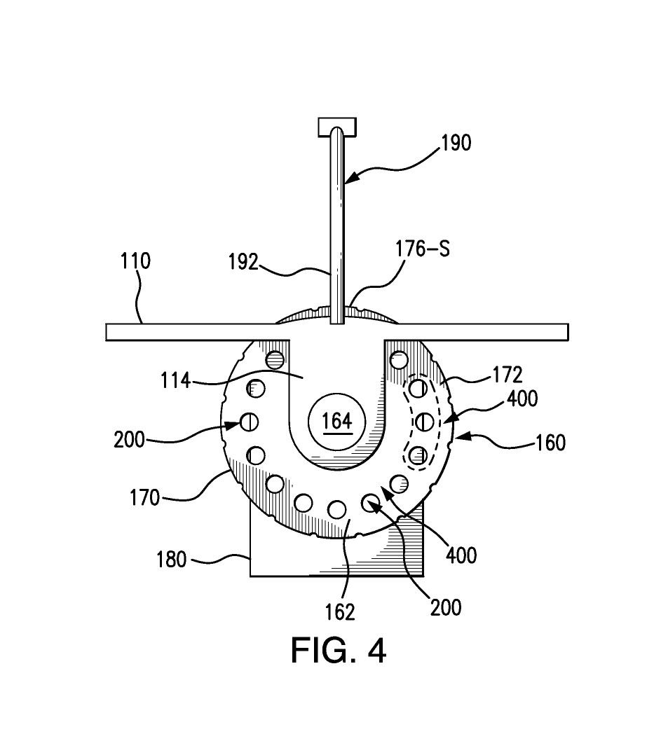

As shown in FIG. 4, the setting holes 200 are spaced apart and extend through a sector 400 of the wheel 162 at positions relative to the positions of associated settings from the different selectable settings. The cross-sectional dimension of each setting hole 200, e.g., cross-sectional area or shape, can be increased or decreased to increase or decrease, respectively, a range of movement of the settings dial 160 when the wire 192 of the wire lock mechanism 190 is engaged in a setting hole 200. For example the setting holes can be made larger or elongated (e.g., such as into an oblong shape) to increase the range of movement of the setting dial 160. The settings dial 160 can be operated within a range of settings for each setting hole 200 (e.g., from the initial selected setting to an adjacent setting(s)) so long as sufficient clearance or room is provided within the setting hole 200. For example, the setting hole 200 can be configured with a larger cross-sectional area, as shown by the dotted line 400, to allow for a greater range of movement by the dial 160 when the wire 192 is engaged through the setting hole 200. Thus, a setting hole 200 can be associated with one or more settings.

An operational example will be described with reference to FIGS. 2 and 3. For example, when the wheel 162 of the settings dial 160 is rotated to a selected setting (e.g., to a setting indicator 176-S), an associated setting hole 200-S from the plurality of setting holes 200 aligns with the wire slots 112A and 112B of the casing 110. The wire 192 of the wire lock mechanism 190 can then be inserted through the wire slots 112A and 112B and the setting hole 200-S associated with the selected setting to lock the settings dial 160 at the selected setting.

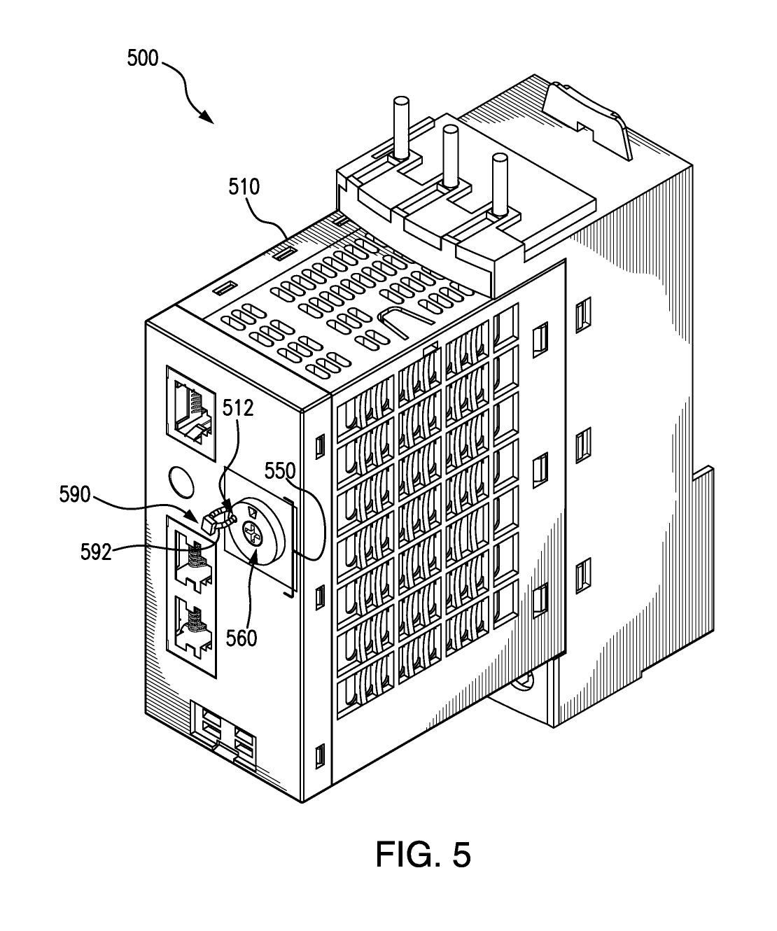

FIG. 5 illustrates a sealable settings dial assembly 550 for electrical equipment 500 in accordance with a second embodiment of the present disclosure. The dial assembly 550 includes a rotary settings dial 560 housed in a casing 510, and a wire lock mechanism 590 with a wire 592. In this example, the settings dial 560 is flat mounted to rotate relative to the casing 510, and allows for selection of a setting from a plurality of different settings for the electrical equipment 500. The wire 592 is directly engaged with the dial 560 through a wire slot(s) 512 adjacent to the dial 560 to lock the dial 560 at a selected setting.

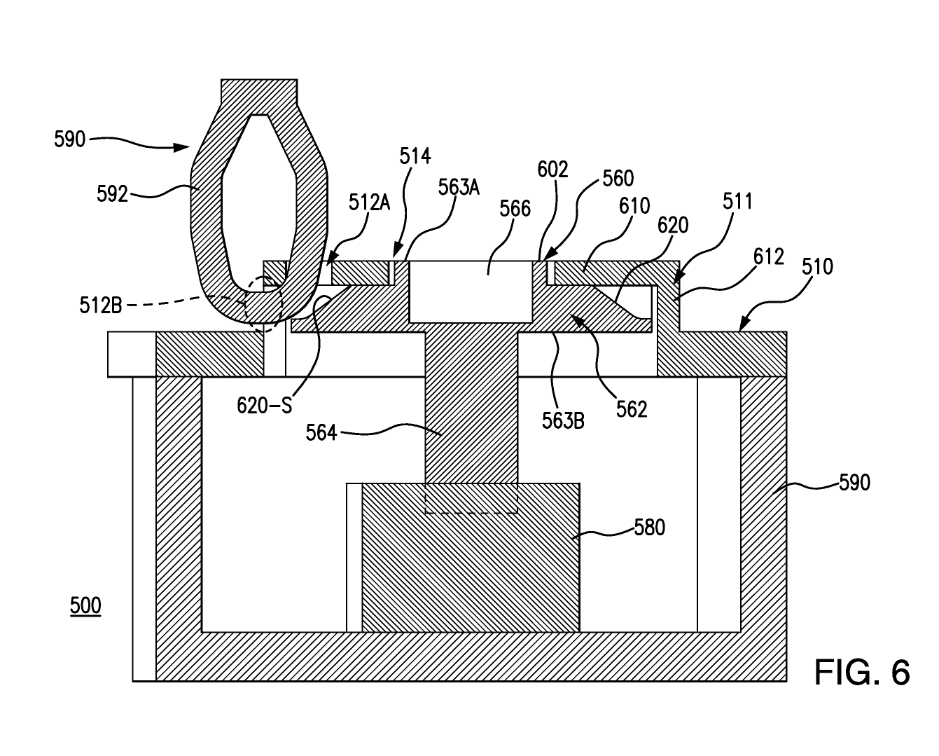

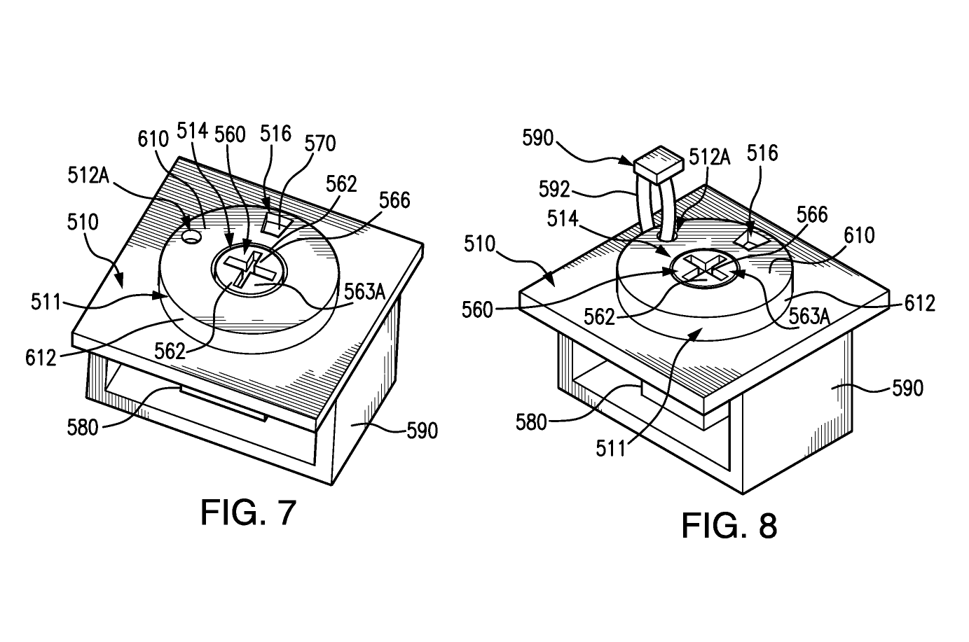

As shown in FIG. 6, the settings dial 560 includes a rotary disc 562 with a shaft 564, and a rotary switch 580 mounted on a support 590 connected to or formed as part of the casing 510. The rotary switch 580 can be a digital switch. The casing 510 includes a raised portion 511 having a top portion 610 and a side portion 612. The top portion 610 includes a first wire slot 512A, tool access opening 514 and a settings indicator window 516 (not shown in FIG. 6, but shown in FIGS. 7 and 8). A second wire slot 512B is provided on the side portion 612 at a position proximate to the first wire slot 512A.

The disc 562 of the settings dial 560 is housed in the raised portion 511 of the casing 510. The disc 562 includes a first side 563A facing the top portion 610 of the raised portion 511 and an opposing second side 563B with the shaft 564 fixedly connected thereto. An end of the shaft 564 is connected to the rotary switch 580, which controls the settings for the electrical equipment 500. In this way, the disc 562 is operable to control the rotary switch 580, thereby enabling selection of a setting from the plurality of different settings. The first side 563A of the disc 562 includes a raised circular portion 602 which is configured to extend into the tool access opening 514 of the casing 510.

The disc 562 includes a plurality of spaced apart radial setting channels, e.g., setting grooves 620, which are associated with the different selectable settings on the settings dial 560. Similar to the first embodiment described above, the cross-sectional dimension of each setting groove 620 can be increased or decreased to increase or decrease, respectively, a range of movement of the settings dial 560 when the wire 592 of the wire lock mechanism 590 is engaged in one of the setting holes 620. For example, the settings dial 560 can also be operated within a range of settings (e.g., from the initial selected setting to an adjacent setting(s)) so long as sufficient clearance or room is provided within the setting groove 620 associated with the initial selected setting. The settings dial 560 can be operated within a range of settings for each setting groove 620 so long as sufficient clearance or room is provided within the setting groove 620. For example, the setting hole 200 can be configured with a larger cross-sectional area to allow for a greater range of movement by the dial 560 when the wire 592 is engaged through the setting groove 620. Thus, a setting groove 620 can be associated with one or more settings.

As shown in FIGS. 7 and 8, the first side 563A of the disc 562 also includes one or more setting indicators 570. The setting indicator 570 for a selected setting is visible through the indicator window 516 of the casing 510. In this example, the selected setting is “1”. The first side 563A of the disc 562 also includes a tool slot 566 which is accessible through the tool access opening 514 of the casing 510. The setting indicators 570 are visible markers that are spaced apart along an outer sector of the first side 561A of the settings dial. The tool slot 566 of the disc 562 is configured with a size and shape to receive a tool which can be used to operate the settings dial 560 to a desired setting. For example, the tool slot 566 can have a cross-hatched configuration for receiving a head from a screw driver.

An operational example will be described with reference to FIGS. 6-8. For example, when the disc 562 of the settings dial 560 is rotated to a selected setting, e.g., to a setting indicator “1”, an associated setting groove 620-S from the plurality of setting grooves 620 aligns with the wire slots 512A and 512B of the casing 510. The wire 592 of the wire lock mechanism 590 can then be inserted through the wire slots 512A and 512B and the setting groove 620-S associated with the selected setting to lock the settings dial 560 at the selected setting.

In the example of FIGS. 6-8, the setting dial 560 is described with setting grooves; however, the setting dial 560 can instead employ spaced apart setting holes. The setting holes can extend from the first side 563A through the disc 562 (e.g., through the second side 563B), and can be arranged at positions relative to the positions of associated setting from the different settings. In this way, the wire 592 of the wire lock mechanism 590 can similarly be inserted through the wire slots 512A and 512B and the setting groove 620-S associated with the selected setting to lock the settings dial 560 at the selected setting. The casing 510 and its wire slots 512A and 512B can be configured to provide a suitable pathway to allow the wire 592 to be looped through the two wire slots and the setting hole for the selected setting.

The various sealable settings dial assemblies, described herein, are provided as examples. The dial assemblies can be incorporated into any type of electrical equipment, which employs a settings dial or the like (e.g., a current settings dial) such as a circuit breaker, contactor, overload relay, sensor and so forth. The settings can include settings for current or other electrical parameters, which are set or pre-set to control operation of the electrical equipment. The components of the sealable settings dial assembly, such as the settings dial and the casing can be formed of dielectric material, such as plastic.

In addition, words of degree, such as “about”, “substantially”, and the like are used herein in the sense of “at, or nearly at, when given the manufacturing, design, and material tolerances inherent in the stated circumstances” and are used to prevent the unscrupulous infringer from unfairly taking advantage of the invention disclosure where exact or absolute figures and operational or structural relationships are stated as an aid to understanding the invention.

While particular embodiments and applications of the present disclosure have been illustrated and described, it is to be understood that the present disclosure is not limited to the precise construction and compositions disclosed herein and that various modifications, changes, and variations can be apparent from the foregoing descriptions without departing from the invention.

1. A sealable settings dial assembly comprising:
a casing for electrical equipment, the casing including a wire slot through which to extend a wire of a wire lock mechanism; and
a rotatable dial, movable relative to the casing, to select a setting from a plurality of different settings for the electrical equipment, the dial including spaced apart setting channels associated with the different settings to be selected, each setting on the dial having associated therewith one of the setting channels which is aligned with the wire slot when the setting is selected on the dial so that the wire is extendable therethrough for locking the dial at the selected setting.

2. The sealable settings dial assembly of claim 1, wherein the setting channels comprises setting holes or setting grooves.

3. The sealable settings dial assembly of claim 2, wherein the dial is vertically mounted in the casing, the dial including a wheel having the setting channels and a shaft, the setting channels comprising spaced apart setting holes extending through a sector of the wheel at positions relative to the positions of their associated settings from the different settings.

4. The sealable settings dial assembly of claim 3, wherein the wheel includes an outer diameter having spaced apart setting indicators which identify the different settings for selection.

5. The sealable settings dial assembly of claim 3, wherein the casing includes two wire slots with a portion of the wheel of the dial arranged therebetween, the wire being extendable through the two wire slots and the setting hole associated with the selected setting to lock the dial at the selected setting.

6. The sealable settings dial assembly of claim 2, wherein the dial is flat mounted in the casing, the dial including a disc with a shaft, the disc having a first side and an opposing second side, the setting channels comprising:
spaced apart radial setting grooves arranged on the first side at positions relative to the positions of associated setting from the different settings, or
spaced apart setting holes extending from the first side through the disc and arranged at positions relative to the positions of associated setting from the different settings.

7. The sealable settings dial assembly of claim 6, wherein the first side of the dial further includes spaced apart setting indicators, which identify the different settings for selection.

8. The sealable settings dial assembly of claim 6, wherein the casing includes two wire slots, the wire being extendable through the two wire slots and the setting groove or hole associated with the selected setting to lock the dial at the selected setting.

9. The sealable settings dial assembly of claim 8, wherein the casing includes a raised portion for housing the disc of the dial, the raised portion having a top portion and a side portion, the top portion including a first of the two wire slots, the side portion including a second of the two wire slots.

10. The sealable settings dial assembly of claim 1, further comprising the electrical equipment which comprises an overload relay, contactor, circuit breaker or sensor.

11. The sealable settings dial assembly of claim 1, further comprising a switch, operable via the rotatable dial, to control the setting of the electrical equipment.

12. The sealable settings dial assembly of claim 1, wherein the setting channel has a dimension to allow for operation of the dial within an associated range of settings when the wire is engaged through the setting channel.

13. The sealable settings dial assembly of claim 1, further comprising the wire of the wire lock mechanism.

14. The sealable settings dial assembly of claim 13, wherein the wire is formed of metal or plastic.

15. The sealable settings dial assembly of claim 1, wherein the dial includes a plurality of setting indicators associated with the different settings, the casing including an indicator window to show a setting indicator associated with the selected setting.
